(19) United States
(12) Patent Application Publication
(10) Pub. No.: US 2009/0144238 A1
(43) Pub. Date: Jun. 4, 2009

(54) HIDE AND SEEK GAME TO ELICIT HUMAN INPUT

(75) Inventors: Timothy S. Paek, Sammamish, WA (US); Christopher A. Meek, Kirkland, WA (US); David M. Chickering, Bellevue, WA (US)

Correspondence Address: AMIN, TUROCY & CALVIN, LLP, 127 Public Square, 57th Floor, Key Tower, CLEVELAND, OH, 44114, US

(73) Assignee: Microsoft Corporation, Redmond, WA (US)

(21) Appl. No.: 11/950,134

(22) Filed: Dec. 4, 2007

(51) Int. Cl. G06F 7/00

(52) U.S. Cl. 707/3

(57) ABSTRACT

A hide and seek style game is utilized to elicit human input for use in improving search. Content (e.g., text, image, audio, video . . . ) is uniquely identified and revealed to users. Queries are then specified by users in an attempt to locate the content. In addition to utilizing these queries to return results for the game, the queries, and/or query-derived information, can also be employed to improve search engine retrieval and relevancy, among other things.

### BACKGROUND

The ubiquity of computers and like devices has resulted in digital data proliferation. Originally the sole domain of well-funded companies and research institutions, technology advancements and cost reductions over time have enabled computers to become commonplace in the lives of most everyone. Individuals interact with a plurality of computing devices daily including work/school computers, home computers, laptops and mobile devices such as phones, personal digital assistants, media players, and/or hybrids thereof. Consequently, an enormous quantity of digital data is generated each day including messages, documents, pictures, music, video, etc. However, such data is of minimal use unless quality information can be extracted/isolated and/or organized in a manner that facilitates expeditious retrieval.

Automated mechanisms are a standard approach to facilitate location of valuable information. More specifically, conventional algorithms and/or machine learning techniques are employed. For example, a web crawler (a.k.a. spider, robot) comprises automated scripts that browse the World Wide Web (web) in a methodical manner capturing copies of web pages along the way. The captured pages can then be utilized to generate an index that a search engine can use to return relevant results. Such automated mechanisms can also be employed in a variety of other ways such as to aid identification of undesired, unsolicited bulk messages known as spam, among other things.

While conventional automated mechanisms seek to replicate human reasoning to classify and organize data, some tasks/activities still require or are more accurate with input from humans. Consider images problems, for example. Technologies have not yet advanced to a point where computers can accurately identify elements within pictures or images. Unfortunately, humans are unlikely to be very interested providing required data since it is often tedious and boring work. Accordingly, they need to be motivated to provision such input. For example, individuals are often paid to label images manually, among other things.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to a hide and seek style game to elicit human input. Information is collected from human beings by engaging them in an interactive game of hide and seek. In particular, target content is revealed and users enter queries to locate the content. Users are motivated to continue to locate items based on the entertainment value of the game alone or in conjunction with other rewards and/or prizes. The specified queries capture human perception and knowledge regarding target content. In addition to utilizing this information in game play, it can also be employed elsewhere to improve search retrieval and relevance, among other things.

In accordance with an aspect of the disclosure, an interface component can receive queries directed toward location of uniquely identified content. A game component can provision the uniquely identified content as well as query results or a portion thereof from a search engine.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an information acquisition system in accordance with an aspect of the disclosure.

FIG. 2 is a block diagram of a representative game component according to an aspect of the disclosure.

FIG. 3 is a block diagram of a representative activity component in accordance with an aspect of the disclosure.

FIG. 4 is a block diagram of a representative reward component according to an aspect of the claimed subject matter.

FIG. 5 is an exemplary graphical user interface associated with one implementation of aspects of the disclosure.

FIG. 6 is a flow chart diagram of a method of eliciting human input in accordance with an aspect the disclosed subject matter.

FIG. 7 is a flow chart diagram of a method of rewarding game play according to an aspect of the disclosure.

FIG. 8 is a flow chart diagram of a method of optimizing search in accordance with an aspect of the subject disclosure.

FIG. 9 is a schematic block diagram illustrating a suitable operating environment for aspects of the subject disclosure.

FIG. 10 is a schematic block diagram of a sample-computing environment.

### DETAILED DESCRIPTION

Systems and methods are described hereinafter for eliciting information from humans utilizing a hide and seek style game. More specifically, queries can be acquired from users seeking to locate uniquely identified content or content items. The users can be rewarded with points and/or prizes, among other things, as a function of performance in locating the content, further motivating users to play or continue playing the game. The specified queries not only enable identification of the location of the content but they provide valuable information that can be harnessed to improve search engine functionality, among other things.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

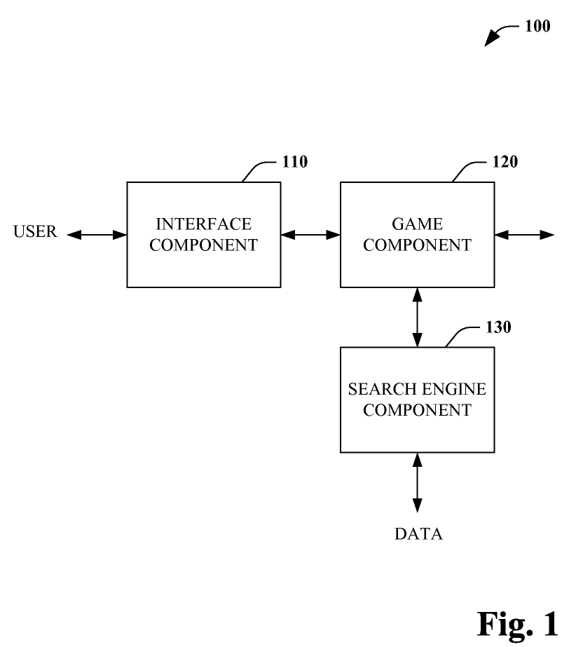

Referring initially to FIG. 1, an information acquisition system 100 is depicted in accordance with an aspect of the claimed subject matter. The system 100 is a mechanism for harnessing human processing power utilizing a game. Information can be captured from users during game play and subsequently employed to improve or enhance other systems. The system 100 utilizes a hide and seek style game to elicit and capture human input. As shown, the information acquisition system 100 includes an interface component 110, game component 120, and search engine component 130.

The interface component 110 provides a mechanism to facilitate interaction with human users. In one instance, the interface component 110 can correspond to a graphical user interface that provides and receives information to and from users utilizing text, graphic, audio, and/or video elements. Alternatively, the interface component 110 can be an application programming interface (API), among other things, that interacts with another component to render and retrieve data. In any event, the interface component 110 can provision and acquire information for the communicatively coupled game component 120.

The game component 120 provides functionality associated with a hide and seek type game. More specifically, an item can be identified that is hidden, for example on the web. Users are challenged to locate or seek out the hidden item by specifying search queries and analyzing the results.

In accordance with one aspect, the game component 120 can provide or otherwise disclose uniquely or distinctly identified content or content items to a user via user interface component 110. This is the item that the user needs to locate. The content can be associated with any item (e.g., object, website, movie . . . ) and can be of any format including text, image (e.g., image of product), audio (e.g., song), and/or video (e.g., clip of a movie), among other things. Moreover, it is to be noted that the content can be distinctive so there is no confusion as to whether such content has or has not been located and to simplify game implementation. As will be described further infra, the content can be augmented in various manners to provide such distinctiveness for example by adding a graphic element or modifying a background.

The game component 120 can subsequently receive user queries in response to providing the content. These queries are directed toward location of the unique content. Users can specify characteristics of the content and or other information that might result in locating the content. For example, if the content is a picture of a person, a query might include the characteristics of the person (e.g., name, attire, ethnicity . . . ), surroundings (e.g., football game, mountain, ocean, monument . . . ), and/or time of day or year (e.g., dusk, evening, fall, spring . . . ). Further yet, particular locations where content might reside can be specified such as uniform resource locators (URLs).

The game component 120 can interact with the search engine component 130 to respond to user queries. Received or retrieved user queries can be provided by the game component 120 to the search engine component 130. Query results identified by the search engine component 130 or a portion thereof can then be passed back to a user by the game component 120 through the interface component 110. In one implementation, the content may be accessible by the search engine component 130 and returned in response to the query. Alternatively, the content can be injected into the results when desired. Accordingly, the game component 120 can control what query results are returned to a user.

As will be discussed in later sections, the game component 120 can also employ various strategies to motivate users to play or continue to play the game. While the game's entertainment factor alone may be enough to attract and retain players, other incentives can be provided. For example, users can score points and compete with others for the best record. Additionally or alternatively, prizes may be provided.

As shown, the game component 120 and the search engine component 130 can be autonomous components. In one implementation, the game component 120 can act as a proxy over an existing search engine, wherein search results are requested, filtered, and provided back to a user with or without target content. It is also to be noted that the system 100 or game component 120 can include their own specialized search engine component 130 more tightly integrated with the game rather than operating over an existing engine.

User queries provide valuable insight regarding the content. In fact, they embody human perception, thought and/or knowledge. Upon presentation, a human being analyzes content in complex manners and identifies factors that may assist in locating the content. For instance, a user can identify portions of the provided content. Additionally or alternatively, a user can decipher significance of portions of content and/or identify innate or other relationships or connections that may not be explicitly provided. This human knowledge can be harnessed by the game component 120 and provided to other components to improve performance of systems or methods.

By way of example, not limitation, the game component 120 can provide such information to the search engine component 130 and/or other associated components to aid search. As previously mentioned, it is particularly difficult for search engines to identify relevant images in part because computer related technologies are not able to extract information from such content as is done for textual content. By providing an image to a user and requiring him/her to enter queries to find the image, the game component 120 is able to collect significant information regarding the image. This data can then be utilized to label or tag images to allow a search engine to identify the content and/or to compute relevancy scores controlling the order of presentation, for instance. This information can be applied in many other scenarios related to search or other technologies. For instance, such information can be employed as training data to train models utilized for computer vision and/or machine learning applications, inter alia.

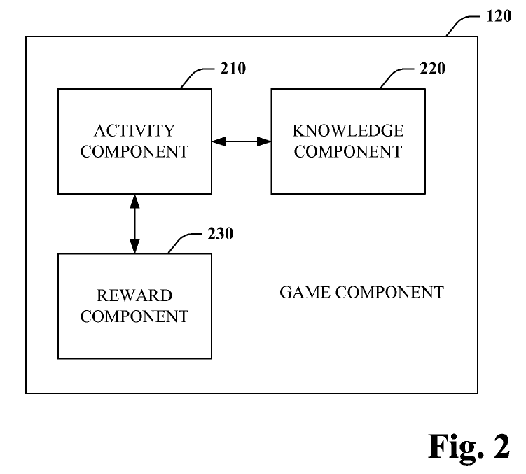

Turning attention to FIG. 2, a representative game component 120 is illustrated in accordance with an aspect of the claimed subject matter. As illustrated, the game component 120 includes an activity component 210, knowledge component 220, and a reward component 230. The activity component 210 provides functionality and/or resources related to identifying content for location, receiving queries, and provisioning results. The knowledge component 220 captures information queries entered for a given content item and disseminates this information or knowledge to other components, entities or the like, for example to improve search. The reward component 230 provides motivational incentives to play and continue playing the game including awarding points, prizes, and the like.

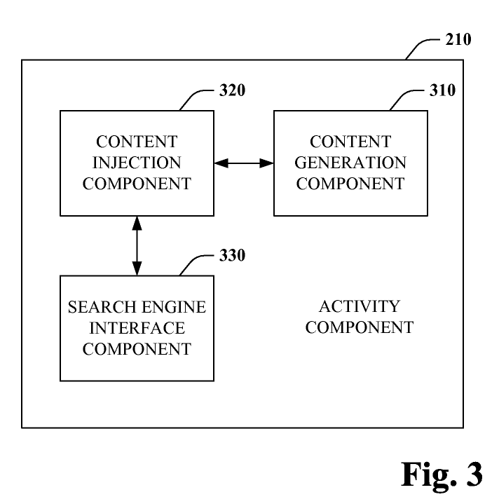

FIG. 3 depicts a representative activity component 210 according to an aspect of the subject matter claimed. The activity component 210 includes a content generation component 310. Content can include text, graphics, audio, and/or video, among other things. According to one aspect of the claimed subject matter, content can be uniquely identified to facilitate a hide and seek type game (although the game can also be implemented without unique identification for example by comparing target content to located content). The content generation component 310 can receive, retrieve or otherwise acquire content from one or more sources and augment the content in a distinct manner. For instance, the content can be framed in a special way, a graphic can be added, and/or image color can be changed, among other things. By way of simple example, a gold pot can be associated with content by adding or stitching it into an image. The game can then be directed to finding content including the gold pot.

The activity component 320 also includes content injection component 320 communicatively coupled to the content generation component 310. The injection component 320 provisions the generated content for initial reference and subsequently in result sets. Search engine interface component 330 interfaces with a search engine to retrieve results in response to a user specified query. The injection component 320 injects the content of interest into or conversely withholds the content of interest from the results provided by a search engine.

Content injection functionality can be implemented in many different ways. For instance, the unique content can be shown if in fact the original content is returned by the search engine. In this manner, information is collected regarding which queries do not match. However, the unique content could still be withheld even though the content is returned by a search engine to enable collection of additional information. Another implementation of the content injection component 320 can keep a log of what people typed in as their queries and the unique content will only be shown if the query matches that of other users and the query has not be returned beyond a threshold amount of times. In this manner, queries that originally would return the unique content later will not to enable collection of different queries.

Additionally or alternatively, a distance metric can be employed between the unique content and the search engine resultant content. Once the distance is within a predetermined range, the unique content can be injected. Among other things, this will eliminate some user frustration when the unique content is not being injected to enable collection of additional or alternate information. Similarly, query similarity between the query and known content metadata such as labels can be employed. By way of simple example, if the unique content is a digital camera model se800 and a user query is “digital camera,” the content injection component 320 could decide to present the unique content based on semantic similarity of the query. For instance, after entering queries including the terms “digital camera” several times the unique content could be injected in the result set so as not to frustrate or discourage the game player.

It is also to be appreciated that the content injection component 320 need not be employed to inject content within the result set. In accordance with one embodiment, the content can reside anywhere on the World Wide Web, for instance. This can be implemented by employing a proxy to insert uniquely identified content on any web page by re-rendering the page, among other ways.

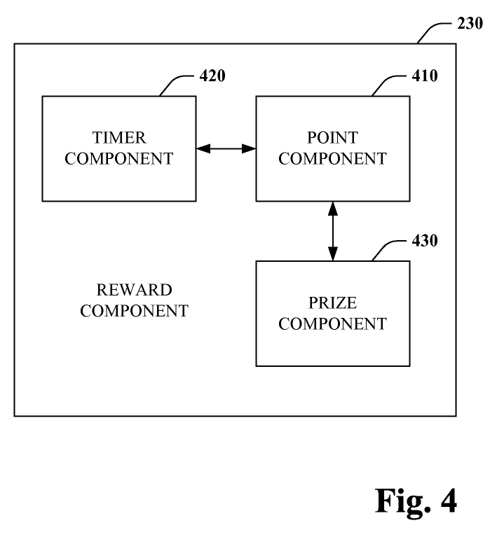

FIG. 4 illustrates a representative reward component 220 in accordance with an aspect of the claimed subject matter. As mentioned, hide and seek style game participation can be motivated utilizing the reward component 220. Here, the representative reward component includes a point component 410 that assigns users points for game participation and/or performance. The reward component 410 can also include a timer component 420 communicatively coupled to the point component 410. By way of example, a user may be given five minutes to locate as many instances of unique content as possible. Points can then be assigned based thereon. Further, additional points may be added for particularly expeditious content location and/or subtracted for lengthy location periods. In one instance, point totals for all users can be posted publically to encourage additional game play, for instance to obtain the top score. Additionally or alternatively, accumulated points can be utilized to obtain prizes. Prize component 420 governs provisioning of prizes as a function of points. For example, an electronic coupon for a product could be provided to users upon reaching a point threshold, rapidly locating an image of that product, or winning a competition. The prize component 430 can also act as a virtual store where points can be utilized to purchase products and/or services alone or in combination with other methods of payment.

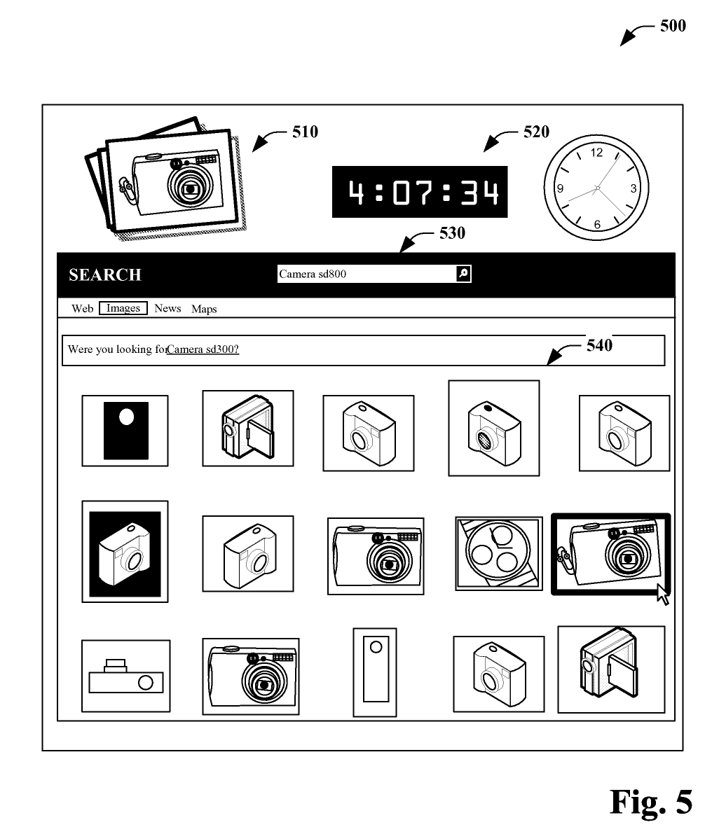

Turning to FIG. 5, an exemplary graphical user interface 500 is shown to facilitate clarity and understanding with respect to a specific implementation of the claimed subject matter. This is, of course, only one implementation. Many other implementations are possible with the same or different interfaces. Accordingly, the claimed subject matter is not intended to be limited by the exemplary graphical user interface 500 in any way. In fact, the interface 500 is presented solely to aid clarity and understanding.

The user interface 500 depicts uniquely identified content at reference numeral 510. The content is an image of a Cannon digital camera model se800. Here, the content is uniquely identified by an inserted graphic of a paper clip character hiding behind the left side of the camera. This can be referred to as the target of a search. Also provided are two timers or clocks 520 that specify time left for content location and text box 530 for entry of a query. Results are displayed in area 540.

The game can be played as follows. First, a uniquely identified content item 510 is identified and the timer is set to five minutes. As soon as a user enters a search in text box 530, the clocks 520 start running. The user then has five minutes to find uniquely identified content items in that time period. Each time a search or query is entered in text box 530 results are displayed in area 540. The image 510 has to match exactly with that in the result set. Accordingly, if the content is not located initially, users can continually adjust their searches. Once the content is found as shown in FIG. 5, the user selects the content. Subsequently, a new image is presented and the game continues until time expires. When the game ends, the number of times content was found is identified together with points awarded from the current game. In one instance, a competition can be held and at the end, the user with the highest score can win one of many prizes.

The game has several nice properties. First, the game can control all search results. Accordingly, it can control where and even when the unique content is returned. Query refinement can also be manipulated by displaying very similar content, for example visually similar images. Furthermore, the game has a single player setup. Hence, users need not wait to be paired with other users for game play and there is no risk of collusion amongst players. An additional benefit in the image spaces is that it is hard to defraud using bots.

The data produced by the game can be employed in a plurality of different ways. In one instance, the data can be used to improve relevance. For example, if an image appears for a query and there is no data from the query labeling the image, it can be determined to be less relevant. Further, content retrieval can be improved. Games can provide multiple labels for content especially low click-through items. The resultant data or information can also enable labels to be identified that are more naturalistic. Furthermore, a ranking of features used for selecting keywords can be set. The data can also be used as training data to improve extraction of labels for images, for example. Still further yet, the data can be utilized for personalization. Collecting information about players can improve relevance (e.g., Adam Ant for “ant”).

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the game component 120 can employ such mechanism to determine or otherwise infer when target content should be shown or injected within search results to maximize quality information collection with the least negative impact on user experience.

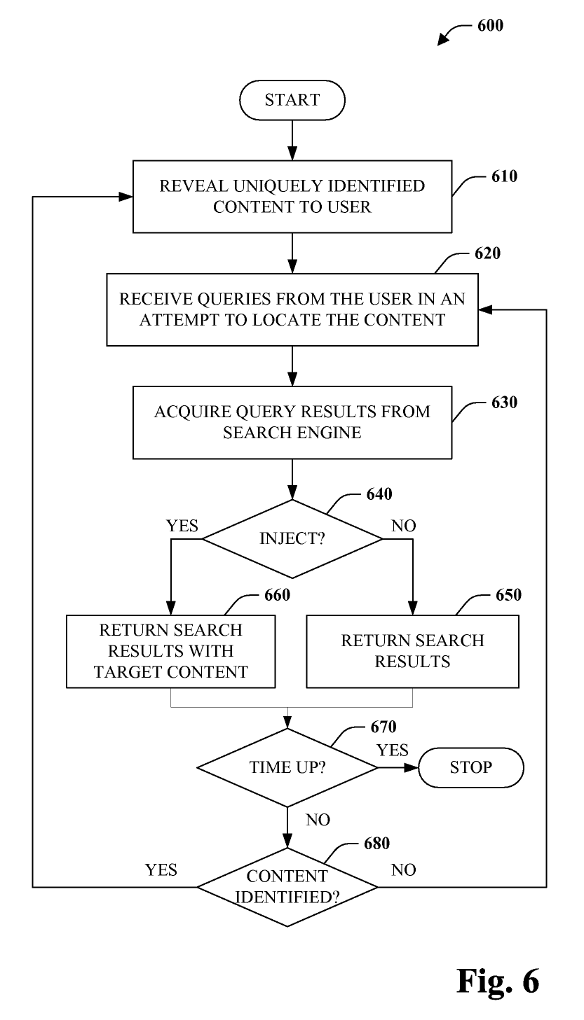

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a method of eliciting human input 600 is illustrated in accordance with an aspect of the claimed subject matter. At reference numeral 610, uniquely identified content (e.g., text, image, audio, video . . . ) is revealed to a user. The content can be distinguished from the same or like content by augmenting the content in a unique manner, for example by adding a paper clip character to an image. Such content provides a target that a user needs to locate. At numeral 620, queries are received from users in an attempt to locate the target content. Query results are acquired from a search engine at reference 630. At reference numeral 630, a determination is made as to whether or not to inject the target content into the result set. This determination can be made based on a variety of factors including the query itself and/or user tolerance, among other things. If at 630, target content is not to be injected the search results or a subset thereof can simply be returned at 650 and the method continues at numeral 670. Alternatively, the target content is injected within the search results or a subset thereof and returned at reference 660. The method continues at 670 where a determination is made as to whether a time threshold has been met. If yes, the method terminates. If no, the method proceeds at numeral 680 where a determination is made concerning whether a user has identified the target content, for example by clicking on it or otherwise gesturing toward it. If the target content is not identified at 680, the method continues at numeral 620 where another query is retrieved from a user. If the target content is identified at reference 680, then the method can proceed to numeral 610 where different target content is revealed.

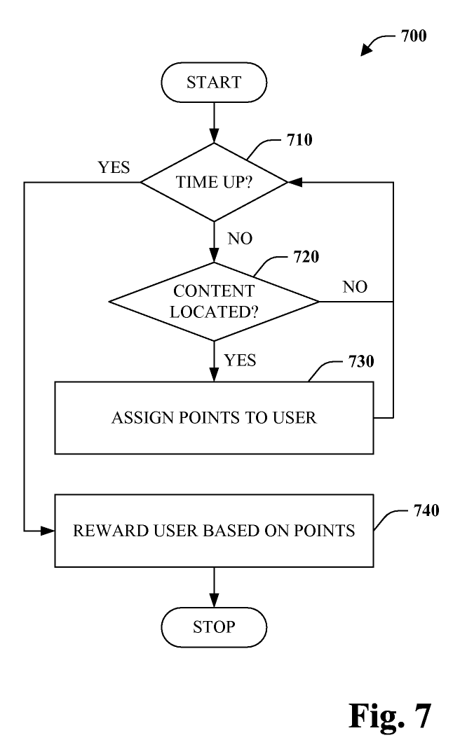

FIG. 7 illustrates a method of rewarding game play 700 in accordance with an aspect of the claimed subject matter. At numeral 710, a check is made to determine if time is up or has expired for a game. If no, a determination is made as to whether the target content has been located at reference 720. If the target content is not located, the method loops back to numeral 710 where the time is checked. If the target content is located, at 720, the method first proceeds to 730 prior to looping back to numeral 710. At reference numeral 730, points are assigned for target content location. The points can be a set amount or may vary as a function of the time it took to locate the target content, among other things. If at numeral 710 it is determined that time has expired, the user can be rewarded as a function of the content located and/or points accumulated at reference numeral 740. For example, a prize can be sent to the user. In one instance, the prize can be one or more coupon for a discount on a product or set of products located during the game.

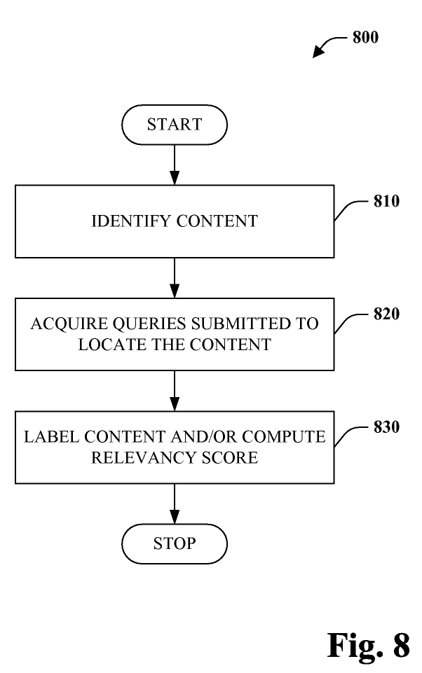

Referring to FIG. 8, a flow chart diagram of a method of optimizing search 800 is illustrated in accordance with an aspect of the claimed subject matter. At reference numeral 810, distinct content is identified. For instance, a video can be identified that includes a distinct frame or stitched graphic element. Queries are received seeking to locate the content at numeral 820. At reference 830, content can be labeled and/or a relevancy score computed as a function of the received queries.

The queries encapsulate user perception and/or knowledge related to the content. Accordingly, such information can be utilized to label content. For instance, where no data or metadata exists regarding an image, user queries for the image can reveal information that can be utilized to tag or label the image. By way of example, if a query is “Clifford big red dog,” the content can be tagged with this information to improve subsequent search engine performance for searches including those labels. More specifically, the content can now be returned where previously it would not have been returned. The converse is also true, namely queries that do not return the content can be employed as exclusionary labels.

Relevancy can also be affected by the queries. For instance, where searches include the same queries, repeated queries or search terms can be considered more relevant that others. In the previous example, if the terms “red” and “dog” appear in game queries many more times than the other terms, this can indicated that “red” and “dog” are more relevant than “Clifford” and “big.” Furthermore, users' first entered queries can be weighted more heavily than subsequent guesses since the first impression can be more important that subsequent hard thought queries. This and other information can be afforded to a search engine to affect relevancy rankings of search results, among other things.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

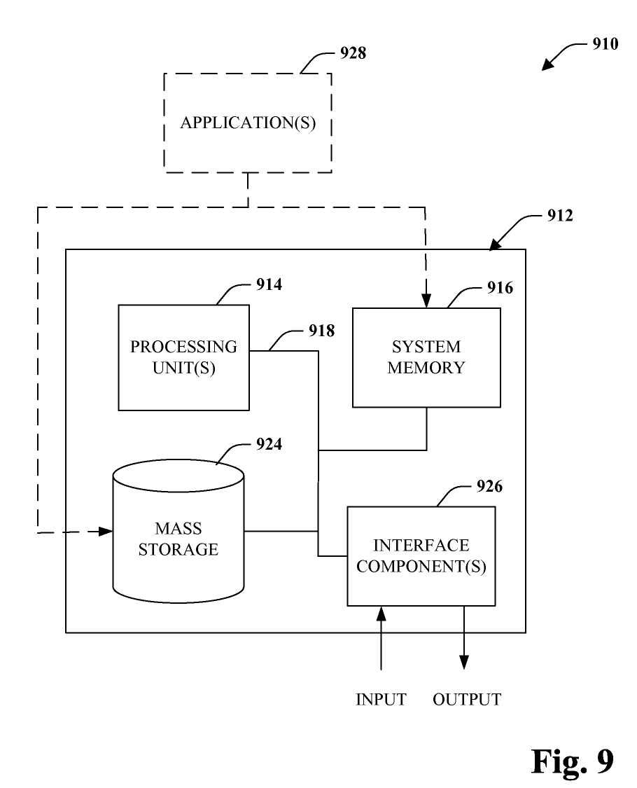

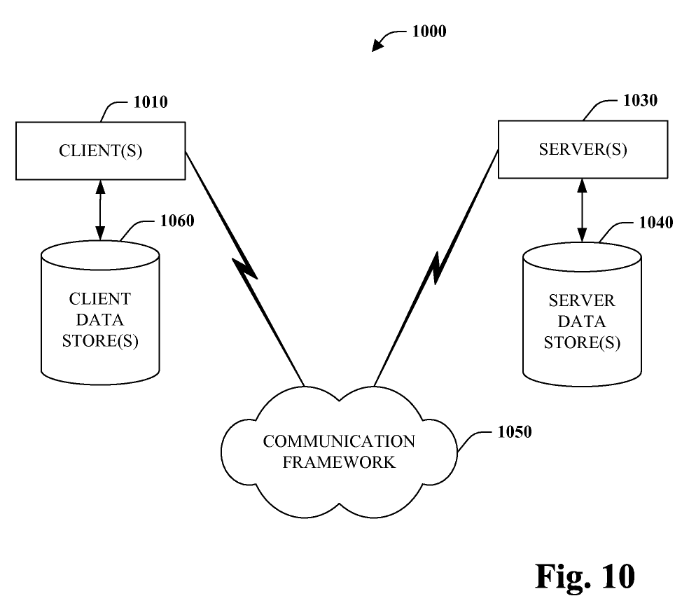

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 910 for implementing various aspects disclosed herein includes a computer 912 (e.g., desktop, laptop, server, hand held, programmable consumer or industrial electronics . . . ). The computer 912 includes a processing unit 914, a system memory 916, and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory, or memory stick. In addition, mass storage 924 can include storage media separately or in combination with other storage media.

FIG. 9 provides software application(s) 928 that act as an intermediary between users and/or other computers and the basic computer resources described in suitable operating environment 910. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

Client/server interactions can be utilized with respect with respect to various aspects of the claimed subject matter. By way of example and not limitation, the game can be provided by one or more servers 1030 to one or more clients 1110 utilizing the communication framework 1050. In accordance with one implementation, the game can act as a proxy over a server provided search engine resident on another server 1050 or client 1010. Accordingly, the game and search engines can be distributed across one or more clients 1010 and servers 1030. Further yet, information captured from the game can be utilized to improve network accessible search engine retrieval and relevancy, among other things.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A human input acquisition system, comprising:
an interface component that receives queries from a user specified to locate uniquely identified content; and
a game component that provisions the content and query results.

2. The system of claim 1, further comprising a search engine component that returns at least a portion of the query results.

3. The system of claim 1, further comprising an injection component that injects the content into the query results.

4. The system of claim 3, the injection component determines a distance metric between a query and the query results and injects the content as a function of the metric.

5. The system of claim 1, further comprising a component that generates the content.

6. The system of claim 1, further comprising a component that awards points to a user as a function of the number of content items located within a period of time.

7. The system of claim 1, the content is one of an image, audio, and/or video.

8. The system of claim 1, the queries are provided to a search engine to label content and/or compute relevancy.

9. The system of claim 1, the queries are training data for model generation.

10. A method of eliciting human input for identifying content, comprising:
revealing distinctly identified content to a user;
receiving queries from the user seeking to locate the content; and
returning results in response to the queries.

11. The method of claim 10, further comprising awarding points to users who locate the content.

12. The method of claim 11, awarding points as a function of time needed to locate the content.

13. The method of claim 10, further comprising labeling the content as a function of the received queries to aid retrieval thereof.

14. The method of claim 10, further comprising computing a relevancy score as a function of the received queries for search results.

15. The method of claim 10, further comprising returning the content when the content is returned by a search engine.

16. The method of claim 10, further comprising computing a distance metric between the queries and the results and returning the content as a function thereof.

17. The method of claim 10, further comprising generating the uniquely identified content.

18. The method of claim 10, comprising revealing uniquely identified images, audio, and/or video.

19. A human input acquisition system, comprising:
means for acquiring queries from users seeking to locate uniquely identified content; and
means for supplying query results provided by a search engine and the content.

20. The system of claim 19, further comprising a means for labeling the content based on the queries.
